(19) United States
(12) Patent Application Publication
(10) Pub. No.: US 2017/0100905 A1
(43) Pub. Date: Apr. 13, 2017

(54) HEAVY DUTY MOBILE METAL SCRAP COMPACTOR, SHEAR AND BALER

(71) Applicant: EXODUS MACHINES INCORPORATED, Superior, WI (US)

(72) Inventors: Derek WENTE, South Range, WI (US); Bruce BACON, Duluth, MN (US)

(73) Assignee: EXODUS MACHINES INCORPORATED, Superior, WI (US)

(21) Appl. No.: 14/877,064

(22) Filed: Oct. 7, 2015

(51) Int. Cl. B30B 9/32; B60S 9/02; B62D 53/00

(52) U.S. Cl. CPC B30B 9/326; B62D 53/005; B60S 9/02

(57) ABSTRACT

A heavy duty mobile metal scrap compactor, shear and baler machine includes a frame having a front end, an intermediate section and a rear end. A power, hydraulic and control station is mounted on the rear end of the frame. A compactor/baler station is mounted on the intermediate section of the frame. A guillotine shear station is mounted on the front end of the frame. At least three axels with twelve wheels are mounted under the frame at the rear end. Vertically adjustable feet are mounted under the frame at the intermediate section and front end. A booster trailer is removably mountable to the rear end of the frame to spread some of the machine's weight onto the booster when moving the machine down a highway. A gooseneck hitch is removably mountable to the front end of the frame adapted to be hooked up to a fifth wheel of a tractor vehicle to move the machine around to a desired parking position.

### BACKGROUND OF THE INVENTION

The demolition and recycling of building materials, namely concrete and metallic items, for reclamation of steel by steel mills or forges is quite common throughout the world. This invention relates recycling of demolished metal scrap and more particularly to a mobile heavy duty metal scrap compactor, shear and baler.

Buildings and metallic item, such as cars, trucks, railroad cars and tracks, appliances, rebar, tin, pipes and I beams, do wear out for their intended useful purposes. When this happens the buildings become a demolition site and are demolished by explosives or with heavy duty shears and crushers typically mounted on the boom structure of a backhoe vehicle. The backhoe can move about the demotion site to tear down the building and reduce the size of the debris. In some cases, the concrete is reduced further on site to small pieces with concrete crushers. Much of the metal, concrete and wood debris are sorted on the demolition site with heavy duty grapples typically mounted on the boom structure of a backhoe vehicle. The sorted debris is then loaded into trucks or trailers and hauled to scrap yards for further reduction and recycling.

In the case of many items that are not fixed to the ground, such as cars, trucks and appliances, they are hauled to scrap yards with trucks and trailers for demolition and recycling. At the scrape yard these items are subject to be torn apart and further sorted by material types like rubber and metal. Metal items are often bulky and may further be reduced by shearing with either stationary or mobile shears. Crushers (or compactors), balers and shears are used to reduce the metal scrap to acceptable size requirements as set by steel mills and forges for melt down reclamation and re-use of the metal to make new items.

Heavy duty scrap shears, balers or compactors are commonly fixedly mounted on pedestals in scrap yards and recycle buildings. The shears, balers and compactors have been combined into one unit or machine 10, as shown in FIG. 1. Machines of this these types are predominantly made in Europe, such as by COPEX-Z.I. KERPONT-B.P. 328, 56603 Lanester Cedex-France (www.copex.com) or LEFORT Rue Tahon, 1 A 6041-Gosselies-Belgium (www.lefort.com).

The machine 10 typically has a frame 12 that stands on pedestals or feet 14 distributed between the frame 12 and the ground. The frame 12 has a front end 16, a rear end 18 and an intermediate section 26. The machine is mounted onto the frame and is comprised of three main components. At the front end 16 is located the power, hydraulic and control station 22 with or without an operator cab 24 as the machine 10 could also be operated by a remote control panel. Here is located a diesel engine or electric drive that powers hydraulic pumps for all moving parts on the machine.

At the intermediate section 26 of the machine 10 is mounted the elongate loading and crushing or baling station 30 made of heavy hard metal to support the crushing operation. A hydraulically powered top hatch is on top of the crushing station 30. For loading scrap, the hatch is opened upwardly and outwardly out of the way of the crushing bed or bin. Once loaded, the hatch is closed and the hatch further partially crushes downwardly the metallic debris inside of the crusher bed. Inside the bed and adjacent the power station is located a hydraulically powered ram or pusher which is longitudinally movable within the bed with one or more huge hydraulic cylinders extending from the power station. Opposite the ram at the other end of the bed is located a reinforced, hydraulically operated heavy door that moves upwardly and downwardly. Adjacent to the door is the shear station 32 having a guillotine shear hydraulically operated that moves upwardly and downwardly. A short chute maybe used to guide the scrap beyond the shear station 32. A machine 10 of this type and size typically weighs 140,000-150,000 pounds or 70-75 tons.

In operation, once the bed is loaded with loose and bulky lighter weight metal scrap, such as tin, the hatch is hydraulically closed and begins to crush and hold the scrap downward. Then the ram is moved to crush, reduce and compact the size of the scrap as the ram is moved toward the door. Ultimately a bale is formed of a size acceptable to a steel mill for reclaiming the metal for future use. Then the door is moved upwardly out of the way and the ram pushes the bale past the retracted, upwardly located shear and optionally onto a downwardly located chute which directs the bale out of the combined unit 10 for further handling and transport. Then the unit is reloaded and the process is repeated.

If the bed is loaded with loose, bulky heavier weight metal scrap, the hatch is hydraulically closed and begins to crush and hold the scrap downward. Then the ram is moved to crush, reduce and compact the size of the scrap as the ram is moved toward the door. Then the door is moved upwardly out of the way and the ram pushes the compressed scrap past the retracted, upwardly located shear to a desired length after which the ram is stopped and the guillotine shear is brought down upon the compressed scrap to cut it into a steel mill suitable length. Then the shear is retracted up and out of the way and the ram further pushes the newly sheared scrap out onto an optional downwardly located chute or conveyor belt which directs the scrap out of the combined unit for further handling and transport. At the same time another compressed chunk of the scrap is positioned for shearing by the guillotine shear and this process is repeated until the unit needs to be reloaded. This machine process is call logging or baling.

A smaller mobile metal scrap compactor, shear and baler machine 40 is shown in FIG. 2. A typical machine 40 or this type and size weighs 40,000-80,000 pounds or 20-40 tons. The machine 40 has a frame 42 with a front end 44, a rear end 46 and an intermediate section 48. Hydraulic feet 50 are located under the frame 42 adjacent the front end 44. At the rear end 46 are located approximately six axels 54 with four wheels per axel 54. In Europe, axels can be close together unlike North American restrictions. While this machine 40 does not have the capacity of the heavy duty machine 10 of FIG. 1, being mobile gives this machine certain advantages. The power, hydraulic and control station 56 is mounted on the frame 42 at the front end 44. At the intermediate section 48 on the frame 42 is mounted the compactor/baler station 58. At the rear end 46 on the frame 42 is mounted the shear station 60 with optional chute 62. The machine may be moved with a heavy duty tractor 70 having fifth wheel arrangement to receive the pin 74 mounted under the frame 42 below the front end 44 and power station 56. It is important to note that this mobile machine is not allowed to be towed down any road within the United States which are subject to much more restrictive Federal and state laws for heavy and wide loads which can be physically harmful to roads and highways. Again, this is because Europe allows the six axels to be place closely together which is prohibited in North America.

Referring to FIG. 3, currently in the United States, heavy duty metal scrap compactor, shear and baler machines 10 of this type are significantly heavy in weight in the range of 70 to 75 tons with a size range of 50 to 70 feet long, 8 feet wide and 13 to 14 feet tall. A heavy haul trailer 80 is used to deliver the machine 10. Cranes are used to place the machine onto the trailer bed 82. The trailer typically has a rear end 86 with three axels 88 and a front end 90. At the front end 90, a first gooseneck hitch 92 is connected to a second wheeled gooseneck hitch which is further connected to the fifth wheel hitch 96 of the tractor 70. Stingers or booster 84 with two to four axels may also be used to further distribute the weight over the combined machine 10, trailer 80 and tractor 70.

The trailer 80 alone may weigh 30,000 pounds and the necessary heavy duty tractor 70 or semi may weigh 30,000 pounds. So the combination of the machine 10, tractor 70 and trailer 80 may weigh 200,000 pounds or 100 tons that is to be moved down a highway with 12 load axels plus a steering axel.

This weight factor makes the delivery, transport and mobility of this unit very problematic. Heavy haul trailers with stingers or boosters and semi-trucks or tractors are very expensive to own and operate, require special state permitting on highways and must follow heavy haul road laws which may vary from state to state. Most states allow 20,000 pounds per axle for up to three axles. After that, even if you add a fourth axle, you are still limited to only 60,000 pounds for that “group” of axles. So to legally carry more weight, you are required to have a 14 feet space then you are allowed to have another group of axles each of which can handle another 20,000 pounds per axel.

There is a need for a heavy duty metal scrap compactor, shear and baler machine that is mobile and lawful to transport down roads and move about in yards and scrap sites that does not require a heavy haul trailer.

### SUMMARY OF THE INVENTION

A heavy duty mobile metal scrap compactor, shear and baler machine includes a frame having a front end, an intermediate section and a rear end. A power, hydraulic and control station is mounted on the rear end of the frame. A compactor/baler station is mounted on the intermediate section of the frame. A guillotine shear station is mounted on the front end of the frame. At least three axels with twelve wheels are mounted under the frame at the rear end. Vertically adjustable feet are mounted under the frame at the intermediate section and front end. A booster trailer is removably mountable to the rear end of the frame to spread some of the machine's weight onto the booster when moving the machine down a highway. A gooseneck hitch is removably mountable to the front end of the frame adapted to be hooked up to a fifth wheel of a tractor vehicle to move the machine around to a desired parking position.

A principal object and advantage of the present invention is this heavy duty compactor, shear and baler is the combined compactor, shear and baler machine that can be used on U.S. highways without extensive modification or challenges.

Another object and advantage of the present invention is that this is the only machine that is capable of moving within the production site without any modifications and then can be highway ready by attaching the gooseneck and stinger (booster) and is configurable for all North American highways; and is portable onsite with no trailer.

Another object and advantage of the present invention is that a scrap yard recycler can purchase just the heavy duty machine; or, the machine, stinger and gooseneck. Then all that the recycler would need is the tractor to go where he wants/when he wants. Most commonly, a permit is required. However, in many states, you can purchase an annual permit and use pre-determined routes to whatever sites the recycler wishes to go—demotion site or another scrap yard.

Another object and advantage of the present invention is that the machine ‘is’ the trailer as it allows total flexibility with no site permits required, as it is portable.

Another object and advantage of the present invention is that this machine gives the recycler total flexibility and optimum production without being locked into a stationary location.

Another object and advantage of the present invention is that reduces at least 20,000 pounds of weight from the combined heavy machine with integral trailer and the tractor. The heavy duty scrap compactor with shear and baler combined is a heavy machine—about 140,000 lbs. The Tractor typically weighs about 30,000 pounds and the trailer weighs about 30,000 pounds. This invention eliminates the weight of the trailer—typically, 30,000 pounds. So, a total weight of 200,000 pounds, might be reduced to 170,000 lbs. This tractor, combined machine and booster have eight to ten load axels plus the one steering axel. By eliminating the independent trailer, the gross weight is reduced by more than 30,000 pounds. This arrangement eliminates one to two axels which is a distinct advantage.

### BRIEF DESCRIPTION OF THE DRAWINGS

FIG. 1 is a prior art side elevational view of a heavy duty metal scrap compactor, shear and baler machine;

FIG. 2 is a prior art side elevational view of a smaller mobile metal scrap compactor, shear and baler machine;

FIG. 3 is a prior art side elevational view of the heavy duty metal scrap compactor, shear and baler machine placed onto the bed of a heavy haul trailer and tractor arrangement;

FIG. 4 is a side elevational view of a mobile heavy duty metal scrap compactor, shear and baler machine of the present invention, with a stinger and hooked up to a tractor with a gooseneck hitch ready for highway travel; and

FIG. 5 is a side elevational view of a mobile heavy duty metal scrap compactor, shear and baler machine of the present invention, with the stinger and gooseneck disconnected therefrom and ready for operation.

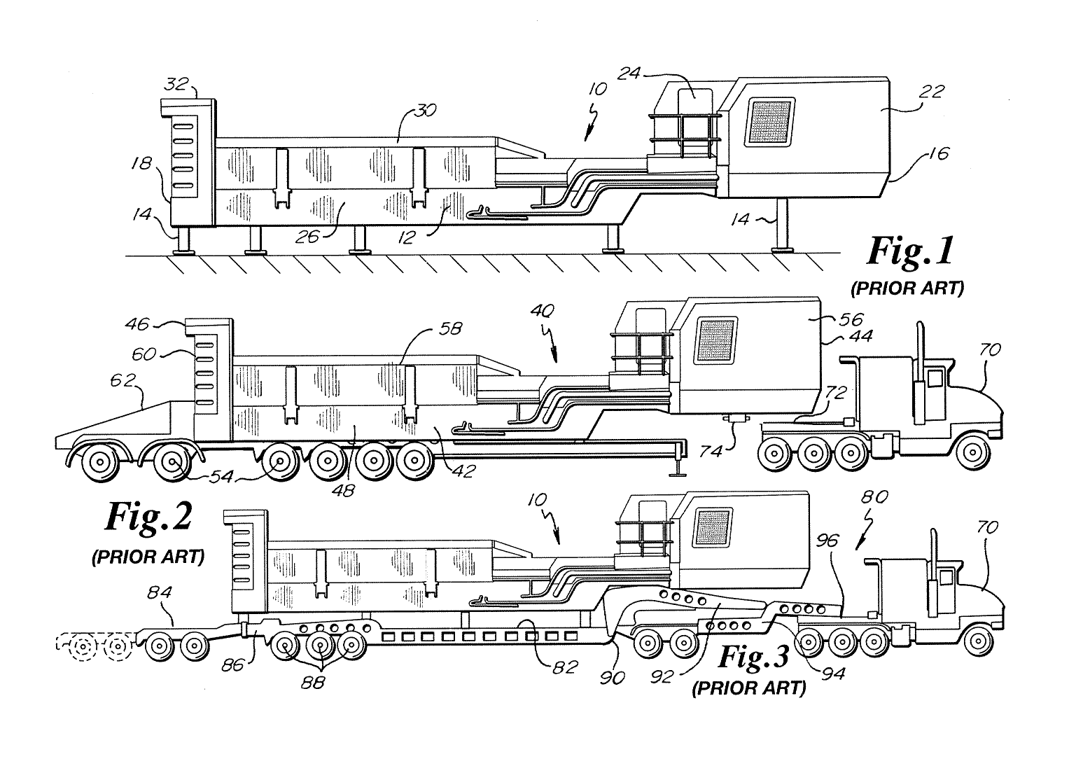

### DETAILED SPECIFICATION

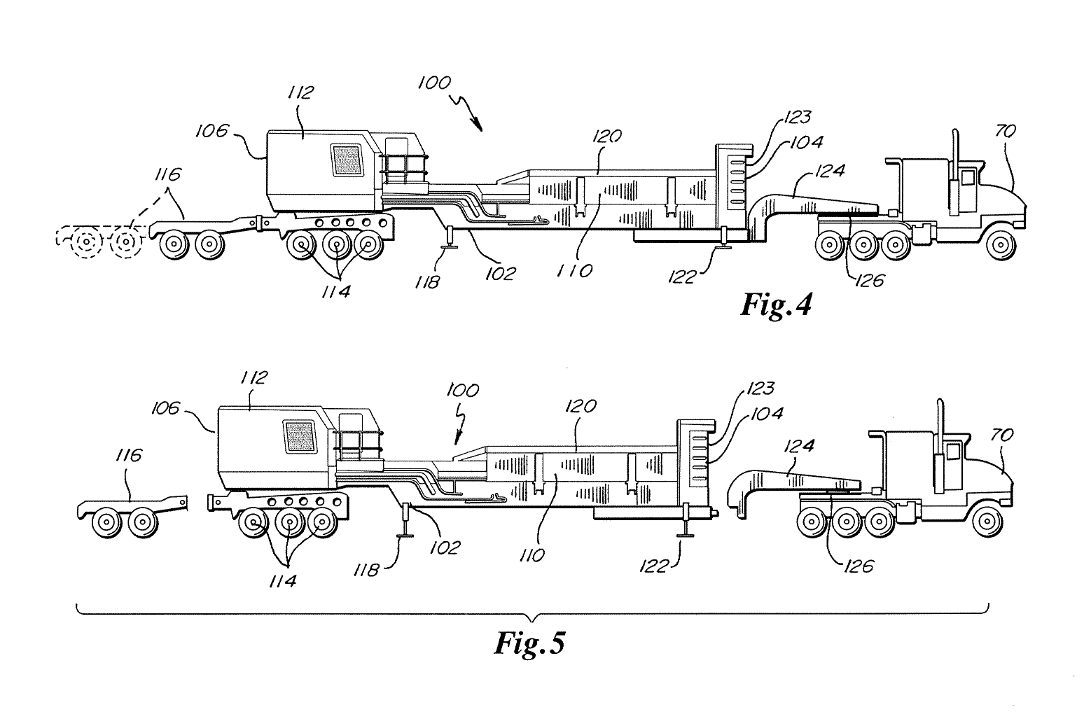

Referring to FIGS. 4 and 5, the heavy duty mobile metal scrap compactor, shear and baler machine 100 of the present invention may be seen and understood.

The machine 100 has a frame 102 which also takes the place of the previously described heavy haul trailer 80. This machine 100 typically weighs 140,000-150,000 pounds or 70-75 tons. The frame 102 has a front end 104, a rear end 106 and an intermediate section 110. The power, hydraulic and control station 112 is mounted on top of the frame 102 at the rear end 106. Three axels 114 with twelve wheels are mounted under the frame below the power station 112 at the rear end 106. This set of axels will carry 60,000 pounds or 30 tons. At the rear end 106 a booster or stinger trailer 116 with two to four axels with eight to sixteen wheels that has a capacity to carry 60,000 pounds or 30 tons. Intermediate section 110 has adjustable hydraulic feet 118 extending downward from the frame 102. The compactor/baler station 120 is mounted to the top of the frame 102 at the intermediate section 110. Shear station 123 is mounted to the top of the frame 10 at the front end 104 which also has adjustable hydraulic feet 122 extending downward from the frame 102. The order of placement of the power station 112 and the shear station 123 may be reverse if so desired. A single gooseneck hitch 124 is removably mounted to the front end 104 of the frame 102.

FIG. 4 shows the machine 100 ready for highway travel. The gooseneck hitch 124 is connected to the front end 104 of the machine and to the tractor 70 with three weight bearing axels capable of carrying up to 60,000 pound or 30 tons. The booster or stinger trailer 116 with two to four axels with eight to sixteen wheels that has a capacity to carry 60,000 pounds or 30 tons. The booster 116 typically weighs between The three axels below the power station 112 will carry 60,000 pounds or 30 tons. The tractor weighs 30,000 pounds or 15 tons. The total weight of the machine 100, booster 116 and tractor 70 ready for transportation is approximately 180,000-220,000 pounds or 90-110 tons and is legal when permitted throughout North America.

FIG. 5 shows the booster 116 and gooseneck 124 disconnected. The machine 100 is ready for operation. Should it be desired to move the machine in a scrap yard, demolition site or within a recycling building, the tractor 70 and gooseneck hitch 124 are hooked up to the machine 100 and the tractor 70 moves forward or backwards to place the machine 100 into its newly desired parking spot.

The above disclosures and accompanying FIGS. are for illustrative purposes and the true scope of the present invention is defined by the following claims.

What is claimed:

1. A heavy duty mobile metal scrap compactor, shear and baler machine, comprising:
a). a frame having a front end, an intermediate section and a rear end;
b.) a power, hydraulic and control station mounted on the rear end of the frame;
c.) a compactor/baler station mounted on the intermediate section of the frame;
d.) a guillotine shear station mounted on the front end of the frame;
e.) at least three axels with twelve wheels mounted under the frame at the rear end; and
f.) vertically adjustable feet mounted under the frame at the intermediate section and front end.

2. The machine of claim 1, further comprising a gooseneck hitch removably mountable to the front end of the frame adapted to be hooked up to a fifth wheel of a tractor vehicle to move the machine around to a desired parking position.

3. The machine of claim 1 wherein the feet are hydraulically activated.

4. The machine of claim 1, further a booster trailer removably mountable to the rear end of the frame to spread some of the machine's weight onto the booster when moving the machine down a highway;

5. The machine of claim 4 wherein the booster has two to four axels with eight to sixteen wheels.

6. A heavy duty mobile metal scrap compactor, shear and baler machine, comprising:
a). a frame having a front end, an intermediate section and a rear end;
b.) a power, hydraulic and control station mounted on the rear end of the frame;
c.) a compactor/baler station mounted on the intermediate section of the frame;
d.) a guillotine shear station mounted on the front end of the frame;
e.) at least three axels with twelve wheels mounted under the frame at the rear end;
f.) vertically adjustable feet mounted under the frame at the intermediate section and front end; and
g.) a gooseneck hitch removably mountable to the front end of the frame adapted to be hooked up to a fifth wheel of a tractor vehicle to move the machine around to a desired parking position.

7. The machine of claim 6 wherein the feet are hydraulically activated.

8. The machine of claim 6, further a booster trailer removably mountable to the rear end of the frame to spread some of the machine's weight onto the booster when moving the machine down a highway;

9. The machine of claim 8 wherein the booster has two to four axels with eight to sixteen wheels.

10. A heavy duty mobile metal scrap compactor, shear and baler machine, comprising:
a). a frame having a front end, an intermediate section and a rear end;
b.) a power, hydraulic and control station mounted on the rear end of the frame;
c.) a compactor/baler station mounted on the intermediate section of the frame;
d.) a guillotine shear station mounted on the front end of the frame;
e.) at least three axels with twelve wheels mounted under the frame at the rear end;
f.) vertically adjustable feet mounted under the frame at the intermediate section and front end;
g.) a booster trailer removably mountable to the rear end of the frame to spread some of the machine's weight onto the booster when moving the machine down a highway; and
h.) a gooseneck hitch removably mountable to the front end of the frame adapted to be hooked up to a fifth wheel of a tractor vehicle to move the machine around to a desired parking position.

11. The machine of claim 10 wherein the feet are hydraulically activated.

12. The machine of claim 10 wherein the booster has two to four axels with eight to sixteen wheels.

13. A heavy duty mobile metal scrap compactor, shear and baler machine, comprising:
a). a frame having a front end, an intermediate section and a rear end;
b.) a power, hydraulic and control station mounted on the rear end of the frame;
c.) a compactor/baler station mounted on the intermediate section of the frame;
d.) a guillotine shear station mounted on the front end of the frame;
e.) at least three axels with twelve wheels mounted under the frame at the rear end;
f.) vertically adjustable, hydraulically activated feet mounted under the frame at the intermediate section and front end;
g.) a booster trailer removably mountable to the rear end of the frame to spread some of the machine's weight onto the booster when moving the machine down a highway; wherein the booster has two to four axels with eight to sixteen wheels; and
h.) a gooseneck hitch removably mountable to the front end of the frame adapted to be hooked up to a fifth wheel of a tractor vehicle to move the machine around to a desired parking position.
